(19) United States
(12) Patent Application Publication
(10) Pub. No.: US 2014/0274445 A1
(43) Pub. Date: Sep. 18, 2014

(54) Golf Club Head Or Other Ball Striking Device With Interchangeable Body Member

(71) Applicant: NIKE, INC., Beaverton, OR (US)

(72) Inventor: Jeremy N. Snyder, Benbrook, TX (US)

(73) Assignee: NIKE, INC., Beaverton, OR (US)

(21) Appl. No.: 13/839,107

(22) Filed: Mar. 15, 2013

(51) Int. Cl. A63B 53/02; B29C 65/48; A63B 53/04

(52) U.S. Cl. CPC A63B 53/02; A63B 53/047; B29C 65/48
USPC 473/307; 473/314; 156/293

(57) ABSTRACT

A ball striking device, such as a golf club, includes a face having a striking surface configured for striking a ball, an iron-type golf club head body connected to the face and extending rearward from the face, a hosel having a proximal end connected to the body and a distal end extending away from the body, and a post member connected to the distal end of the hosel and extending away from the hosel. The post member has a non-circular cross-section and is configured for insertion into a shaft to connect the golf club head to the shaft. The shaft may be provided having complementary connecting structure, such as a bore receiving the post member therein. The face, the body, the hosel, and the connection member may be formed of a polymer material, and may be formed of a single, integral piece of the polymer material.

### TECHNICAL FIELD

The invention relates generally to ball striking devices, such as golf clubs and heads. Certain aspects of this invention relate to golf clubs and other ball striking devices having a ball striking head that is configured to be removably connected to a handle or shaft.

### BACKGROUND

Golf is enjoyed by a wide variety of players—players of different genders, and players of dramatically different ages and skill levels. Golf is somewhat unique in the sporting world in that such diverse collections of players can play together in golf outings or events, even in direct competition with one another (e.g., using handicapped scoring, different tee boxes, etc.), and still enjoy the golf outing or competition. These factors, together with increased golf programming on television (e.g., golf tournaments, golf news, golf history, and/or other golf programming) and the rise of well-known golf superstars, at least in part, have increased golfs popularity in recent years, both in the United States and across the world.

Golfers at all skill levels seek to improve their performance, lower their golf scores, and reach that next performance “level.” Manufacturers of all types of golf equipment have responded to these demands, and recent years have seen dramatic changes and improvements in golf equipment. For example, a wide range of different golf ball models now are available, with some balls designed to fly farther and straighter, provide higher or flatter trajectory, provide more spin, control, and feel (particularly around the greens), etc.

Being the sole instrument that sets a golf ball in motion during play, the golf club also has been the subject of much technological research and advancement in recent years. For example, the market has seen improvements in golf club heads, shafts, and grips in recent years. Additionally, other technological advancements have been made in an effort to better match the various elements of the golf club and characteristics of a golf ball to a particular user's swing features or characteristics (e.g., club fitting technology, ball launch angle measurement technology, etc.).

Despite the various technological improvements, golf remains a difficult game to play at a high level. For a golf ball to reliably fly straight and in the desired direction, a golf club should meet the golf ball square (or substantially square) to the desired target path. Moreover, the golf club should meet the golf ball at or close to a desired location on the club head face (i.e., on or near a “desired” or “optimal” ball contact location) to reliably fly straight, in the desired direction, and for a desired distance. Off-center hits that deviate from squared contact and/or are located away from the club's desired ball contact location may tend to “twist” the club face when it contacts the ball, thereby sending the ball in the wrong direction, often imparting undesired hook or slice spin, and/or robbing the shot of distance. The weighting and weight distribution of a golf club head may influence the moment of inertia and the center of gravity of the club head, as well as the energy and velocity transferred to the ball by the impact. The moment of inertia of the head can be increased, for example, by distributing a greater amount of weight around the perimeter of the head. This, in turn, can reduce the amount of twisting of the club head that occurs on off-center hits, and increase the distance and accuracy of shots on off-center hits. Likewise, the location of the center of gravity of the head can be influenced by the weight distribution of the head. Generally, the desired contact area of the face is aligned with the center of gravity of the head. However, it may be desirable to shift the location of the center of gravity of the head, such as to adjust for common off-center hitting patterns by a golfer, or to produce a certain shot characteristic (e.g., to induce a hook, slice, draw, fade, etc.). For example, a center of gravity that is lower and/or farther backward can produce higher loft and lower spin on the shot, while a center of gravity that is higher and/or farther forward may produce lower loft, greater distance, and higher spin on the shot and/or greater control, each of which may be desirable in certain clubs or for certain golfers. Accordingly, club head features that can permit the weighting and weight distribution of the head to be adjusted or customized may provide improved performance in several ways.

Golf shots occasionally leave the fairway and come to rest on playing surfaces that are capable of damaging a golf club head during a swing, such as a paved or rocky road, cart path, parking lot, or other surfaces that are hard, rough, abrasive, or otherwise capable of damaging the club head. A player may wish to strike the ball while the ball is resting on such a surface, but may risk scratching or other damage to the golf club while doing so. Accordingly, club head features that can minimize the risks of hitting on such a surface may provide desirable performance characteristics. Other types of balls in other sports or activities may similarly be hit while resting on or above surfaces that are hard, rough, abrasive, etc., and devices for striking such balls may encounter similar challenges.

The present device and method are provided to address the problems discussed above and other problems, and to provide advantages and aspects not provided by prior ball striking devices of this type. A full discussion of the features and advantages of the present invention is deferred to the following detailed description, which proceeds with reference to the accompanying drawings.

### BRIEF SUMMARY

The following presents a general summary of aspects of the invention in order to provide a basic understanding of the invention. This summary is not an extensive overview of the invention. It is not intended to identify key or critical elements of the invention or to delineate the scope of the invention. The following summary merely presents some concepts of the invention in a general form as a prelude to the more detailed description provided below.

Aspects of the invention relate to ball striking devices, such as golf clubs, with a head that includes a face having a striking surface configured for striking a ball, an iron-type golf club head body connected to the face and extending rearward from the face, a hosel having a proximal end connected to the body and a distal end extending away from the body, and a post member connected to the distal end of the hosel and extending away from the hosel. The post member has a non-circular cross-section and is configured for insertion into a shaft to connect the golf club head to the shaft. A shaft may be provided having complementary connecting structure, such as a bore receiving the post member therein. The face, the body, the hosel, and the connection member are formed of a polymer material, and may be formed of a single, integral piece of the polymer material. In one embodiment, the post member may have a square or other rectangular cross section.

According to one aspect, an adhesive material may be used to bond the shaft to the post member, wherein the adhesive material has a glass transition temperature that is lower than a glass transition temperature of the polymer material of the post member, and wherein the shaft is configured to be connected to and disconnected from the post member by heating the adhesive material to a temperature between the glass transition temperature of the adhesive material and the glass transition temperature of the polymer material to permit the adhesive material to be bonded or debonded without damage to the shaft or the post member.

Additional aspects of the invention relate to ball striking devices, such as golf clubs, with a ball striking head that includes a face having a striking surface configured for striking a ball, a body connected to the face and extending rearward from the face, a hosel having a proximal end connected to the body and a distal end extending away from the body, and a connection member connected to the distal end of the hosel. The face, the body, the hosel, and the connection member are formed of a polymer material, and may be formed of a single, integral piece of the polymer material. A shaft is removably connected to the connection member of the ball striking head, and an adhesive material bonds the shaft to the connection member of the ball striking head. The adhesive material has a glass transition temperature that is lower than a glass transition temperature of the polymer material of the connection member. The shaft is configured to be connected to and disconnected from the connection member by heating the adhesive material to a temperature between the glass transition temperature of the adhesive material and the glass transition temperature of the polymer material to permit the adhesive material to be bonded or debonded without damage to the shaft or the connection member.

According to one aspect, the connection member may include a post member extending from the distal end of the hosel and the shaft includes a bore receiving the post member therein. The post member may have a non-circular cross-section and the bore may have a complementary non-circular cross-section, such that the post member and the bore are rotationally locked. In one non-circular configuration, the post member and the bore have rectangular cross-sections.

Alternately, according to another aspect, the shaft includes a post member extending from an end of the shaft and the connection member has a bore within the distal end of the hosel and receiving the post member therein. The post member may have a non-circular cross-section, and the bore may have a complementary non-circular cross-section, such that the post member and the bore are rotationally locked. In one configuration, the post member and the bore may have a square or other rectangular shape.

Additional aspects of the invention relate to ball striking devices, such as golf clubs, with a ball striking head that includes a face having a striking surface configured for striking a ball, a body connected to the face and extending rearward from the face, and a hosel having a proximal end connected to the body and a distal end extending away from the body. The face, the body, the hosel, and the connection member are formed of a polymer material, and may be formed of a single, integral piece of the polymer material. A shaft is removably connected to the hosel of the ball striking head.

According to one aspect, the device may further include an adhesive material bonding the shaft to the hosel, where the adhesive material has a glass transition temperature that is lower than a glass transition temperature of the polymer material of the hosel, The shaft is configured to be connected to and disconnected from the hosel by heating the adhesive material to a temperature between the glass transition temperature of the adhesive material and the glass transition temperature of the polymer material to permit the adhesive material to be bonded or debonded without damage to the shaft or the hosel.

According to one aspect, the ball striking head further includes a post member extending from the distal end of the hosel and the shaft includes a bore receiving the post member therein. The post member has a non-circular cross-section and the bore has a complementary non-circular cross-section, such that the post member and the bore are rotationally locked. The post member and the bore may have square or other rectangular cross-sections in one configuration. The post member may also be formed of the polymer material, and may be integrally formed as part of the single piece of the polymer material. An adhesive material as described above may be used to bond the shaft to the post member.

Alternately, according to a further aspect, the shaft includes a post member extending from an end of the shaft and the ball striking head further includes a bore within the distal end of the hosel and receiving the post member therein. The post member has a non-circular cross-section and the bore has a complementary non-circular cross-section, such that the post member and the bore are rotationally locked. The post member and the bore may have square or other rectangular cross-sections in one configuration. An adhesive material as described above may be used to bond the shaft to the head.

Further aspects of the invention relate to a method that may be used in connection with any of the ball striking heads or ball striking devices described above. A ball striking head may be provided that includes at least a face having a striking surface configured for striking a ball, a body connected to the face and extending rearward from the face, a hosel having a proximal end connected to the body and a distal end extending away from the body, and a connection member connected to the distal end of the hosel. At least a portion of the head may be made from a polymer material. An adhesive material in communication with a surface of the connection member of the ball striking head, wherein the adhesive material has a glass transition temperature that is lower than a glass transition temperature of the polymer material of the head. The adhesive material is then heated to a temperature between the glass transition temperature of the adhesive material and the glass transition temperature of the polymer material, in order to permit bonding of the adhesive material. A shaft is then connected to the connection member of the ball striking head by placing a portion of the shaft in communication with the adhesive material, and the adhesive material is cooled after connecting the shaft to the connection member, such that the adhesive material bonds the shaft to the connection member of the ball striking head.

According to one aspect, the face, the body, and the hosel of the ball striking head may all be integrally formed of a single piece of the polymer material.

According to another aspect, the connection member of the ball striking head includes a post member extending from the distal end of the hosel and the shaft has a bore. The shaft is connected to the connection member by inserting the post member in the bore, and the adhesive material is located within the bore to bond the post member to the shaft. The post member has a non-circular cross-section and the bore has a complementary non-circular cross-section, such that the post member and the bore are rotationally locked after connection. The non-circular cross section may be square or another rectangular cross-section in one configuration.

According to a further aspect, the method may further include interchanging the head with a second ball striking head. In this method, the adhesive material is heated a second time to a temperature between the glass transition temperature of the adhesive material and the glass transition temperature of the polymer material, and the shaft is disconnected from the connection member of the ball striking head after heating the adhesive material the second time. The second head includes a face having a striking surface configured for striking a ball, a body connected to the face and extending rearward from the face, a hosel having a proximal end connected to the body and a distal end extending away from the body, and a connection member connected to the distal end of the hosel. At least a portion of the second head may be formed of a second polymer material (which may be substantially the same as the polymer material of the original head). The shaft is then connected to the connection member of the second ball striking head by placing a portion of the shaft in communication with the adhesive material, and the adhesive material is cooled after connecting the shaft to the connection member of the second ball striking head, such that the adhesive material bonds the shaft to the connection member of the second ball striking head. The face, the body, and the hosel of the second ball striking head may be integrally formed of a single piece of the second polymer material.

According to one aspect, the connection member of the ball striking head includes a post member extending from the distal end of the hosel and the shaft has a bore, and the shaft is connected to the connection member by inserting the post member in the bore. The adhesive material is located within the bore to bond the post member to the shaft. The post member has a non-circular cross-section and the bore has a complementary non-circular cross-section, such that the post member and the bore are rotationally locked after connection. The connection member of the second ball striking head likewise includes a post member extending from the distal end of the hosel and the shaft has a bore, the shaft of the second head is connected to the connection member by inserting the post member in the bore. The post member of the second head has the same non-circular cross-section of the post member of the ball striking head, such that the post member of the second ball striking head and the bore are rotationally locked after connection.

Other features and advantages of the invention will be apparent from the following description taken in conjunction with the attached drawings.

### BRIEF DESCRIPTION OF THE DRAWINGS

To allow for a more full understanding of the present invention, it will now be described by way of example, with reference to the accompanying drawings in which:

FIG. 1 is a front view of one embodiment of a ball striking device according to aspects of the present invention, in the form of an iron-type golf club;

FIG. 2 is a front view of a golf club head and an end of a shaft of the ball striking device of FIG. 1, illustrating the head being interchanged with a second, identical golf club head;

FIG. 3 is a top view of the ball striking device of FIG. 1, showing a partial cross-section along lines 3-3 in FIG. 1;

FIG. 4 is a rear view of the head of the ball striking device of FIG. 2;

FIG. 5 is a rear view of the head of the ball striking device as shown in FIG. 4, illustrating weight members integrally contained within the head;

FIG. 6 is a side view of the head and the end of the shaft of FIG. 2, showing a partial cross-section;

FIG. 7 is a magnified view of a portion of the cross-section of FIG. 6, in the area indicated by the bubble A in FIG. 6;

FIG. 8 is a magnified view of the portion of the cross-section as shown in FIG. 7, showing an adhesive material heated above its glass transition temperature; and

FIG. 9 is a front view of another embodiment of a head and an end of a shaft of a ball striking device according to aspects of the present invention, in the form of an iron-type golf club head.

### DETAILED DESCRIPTION

In the following description of various example structures according to the invention, reference is made to the accompanying drawings, which form a part hereof, and in which are shown by way of illustration various example devices, systems, and environments in which aspects of the invention may be practiced. It is to be understood that other specific arrangements of parts, example devices, systems, and environments may be utilized and structural and functional modifications may be made without departing from the scope of the present invention. Also, while the terms “top,” “bottom,” “front,” “back,” “side,” “rear,” and the like may be used in this specification to describe various example features and elements of the invention, these terms are used herein as a matter of convenience, e.g., based on the example orientations shown in the figures or the orientation during typical use. Additionally, the term “plurality,” as used herein, indicates any number greater than one, either disjunctively or conjunctively, as necessary, up to an infinite number. Nothing in this specification should be construed as requiring a specific three dimensional orientation of structures in order to fall within the scope of this invention. Also, the reader is advised that the attached drawings are not necessarily drawn to scale.

The following terms are used in this specification, and unless otherwise noted or clear from the context, these terms have the meanings provided below.

“Ball striking device” means any device constructed and designed to strike a ball or other similar objects (such as a hockey puck). In addition to generically encompassing “ball striking heads,” which are described in more detail below, examples of “ball striking devices” include, but are not limited to: golf clubs, putters, croquet mallets, polo mallets, baseball or softball bats, cricket bats, tennis rackets, badminton rackets, field hockey sticks, ice hockey sticks, and the like.

“Ball striking head” means the portion of a “ball striking device” that includes and is located immediately adjacent (optionally surrounding) the portion of the ball striking device designed to contact the ball (or other object) in use. In some examples, such as many golf clubs and putters, the ball striking head may be a separate and independent entity from any shaft or handle member, and it may be attached to the shaft or handle in some manner.

The terms “shaft” and “handle” are used synonymously and interchangeably in this specification, and they include the portion of a ball striking device (if any) that the user holds during a swing of a ball striking device.

“Integral joining technique” means a technique for joining two or more pieces so that the pieces effectively become a single, integral piece, including, but not limited to, irreversible joining techniques, such as adhesively joining, cementing, and welding (including brazing, soldering, or the like), where separation of the joined pieces cannot be accomplished easily and/or without structural damage to at least one of the pieces.

In general, aspects of this invention relate to ball striking devices, such as golf club heads, golf clubs, putter heads, putters, and the like. Such ball striking devices, according to at least some examples of the invention, may include a ball striking head and a ball striking surface. In the case of a golf club, the ball striking surface is a substantially flat surface on one face of the ball striking head (although, in some structures, the face may include some curvature, e.g., known as “bulge” and/or “roll”). Some more specific aspects of this invention relate to iron-type golf clubs and golf club heads, including long irons, short irons, wedges, etc. Alternately, some aspects of this invention may be practiced with hybrid clubs, chippers, and the like, wood-type golf clubs and the like, or putters.

According to various aspects of this invention, the ball striking device may be formed of one or more of a variety of materials, such as metals (including metal alloys), ceramics, polymers, composites (including fiber-reinforced composites), and wood, and may be formed in one of a variety of configurations, without departing from the scope of the invention. In one illustrative embodiment, some or all components of the head, including the face and at least a portion of the body of the head, are made of a polymer material, which may include a reinforced polymer or other composite, as described in greater detail below. It is understood that the head may contain components made of several different materials. Additionally, the components may be formed by various forming methods. For example, metal components (such as titanium, aluminum, titanium alloys, aluminum alloys, steels (including stainless steels), and the like) may be formed by forging, molding, casting, stamping, machining, and/or other known techniques. As another example, polymeric components may be manufactured using injection molding, blow molding, thermoforming, other types of molding, and/or other known techniques. In a further example, composite components, such as carbon fiber-polymer composites, can be manufactured by a variety of composite processing techniques, such as prepreg processing, powder-based techniques, mold infiltration, and/or other known techniques. It is understood that post-processing (e.g. machining) may be performed in conjunction with any of the above techniques.

The various figures in this application illustrate examples of ball striking devices according to this invention. When the same reference number appears in more than one drawing, that reference number is used consistently in this specification and the drawings refer to the same or similar parts throughout.

At least some examples of ball striking devices according to this invention relate to golf club head structures, including heads for wood-type golf clubs, such as drivers, as well as long iron clubs (e.g., driving irons, zero irons through five irons), short iron clubs (e.g., six irons through pitching wedges, as well as sand wedges, lob wedges, gap wedges, and/or other wedges), hybrid clubs, and putters. Such devices may include a one-piece construction or a multiple-piece construction. Example structures of ball striking devices according to this invention will be described in detail below in conjunction with FIG. 1, which illustrates an example of a ball striking device 100 in the form of an iron-type golf club, in accordance with at least some examples of this invention.

FIG. 1 illustrates a ball striking device 100 in the form of a golf iron, in accordance with at least some examples of this invention, and illustrative embodiments of heads 102, et seq., of ball striking devices 100 of this type and methods of making them are shown in FIGS. 2-15. The golf club head 102 of FIG. 1 may be representative of any iron-type golf club head in accordance with examples of the present invention. As shown in FIGS. 1-4, the ball striking device 100 includes a ball striking head 102 and a shaft 104 connected to the ball striking head 102 and extending therefrom. The ball striking head 102 of the ball striking device 100 of FIGS. 1-2 has a face 112 connected to a body 108, with a hosel 109 extending therefrom. Any desired hosel and/or head/shaft interconnection structure may be used without departing from this invention, including conventional hosel or other head/shaft interconnection structures as are known and used in the art, or an adjustable, releasable, and/or interchangeable hosel or other head/shaft interconnection structure.

As shown in FIGS. 1-8, the golf club head 102 includes a body member 108, a face 112, and a hosel 109 extending from the body 108 for attachment of the shaft 104. For reference, the head 102 generally has a top 116, a bottom or sole 118, a heel 120 proximate the hosel 109, a toe 122 distal from the hosel 109, a front 124, and a back or rear 126. The shape and design of the head 102 may be partially dictated by the intended use of the device 100. The heel portion 120 is attached to and/or extends from the hosel 109 (e.g., as a unitary or integral one piece construction, as separate connected elements, etc.). The head 102 as shown in FIGS. 1-8 is solid, but may contain one or more internal cavities in one embodiment. Additionally, the head 102 as shown in FIGS. 1-8 has a blade-type construction, but in other embodiments, the head 102 may have a full or partial rear cavity that may be at least partially exposed to the exterior of the head 102, as known in the art. In the embodiment illustrated in FIGS. 1-8, the hosel 109 has a proximal end 128 that is connected to the body 108 at the heel 120 and a distal end 129 that extends away from the body 108 in an outward and/or upward direction. The proximal and distal ends 128, 129 of the hosel 109 may alternately be referred to as a fixed end and a free end, respectively.

The face 112 is located at the front 124 of the head 102, and has an outer surface or striking surface 110 configured for striking a ball (not shown), as well as an inner surface 111 located opposite the striking surface 110. The face 112 is defined by a plurality of peripheral edges, including a top edge 113, a bottom edge 115, a heel edge 117, and a toe edge 119. The face 112 also has a plurality of face grooves 121 on the striking surface 110. For reference purposes, the portion of the face 112 nearest the top face edge 113 and the heel 120 of the head 102 is referred to as the “high-heel area”; the portion of the face 112 nearest the top face edge 113 and toe 122 of the head 102 is referred to as the “high-toe area”; the portion of the face 112 nearest the bottom face edge 115 and heel 120 of the head 102 is referred to as the “low-heel area”; and the portion of the face 112 nearest the bottom face edge 115 and toe 122 of the head 102 is referred to as the “low-toe area”. Conceptually, these areas may be recognized and referred to as quadrants of substantially equal size (and/or quadrants extending from a geometric center of the face 112), though not necessarily with symmetrical dimensions. For at least some types of club heads, the face 112 may include some curvature in the top to bottom and/or heel to toe directions (e.g., bulge and roll characteristics), as is known and is conventional in the art for such clubs. As seen in the illustrative embodiments in FIGS. 2-5, the striking surface 110 is inclined (i.e., at a loft angle), to give the ball an appreciable degree of lift and spin when struck. In other illustrative embodiments, the ball striking surface 110 may have a different incline or loft angle, to affect the trajectory of the ball. In other applications, such as for a different type of golf club, the head may be designed to have different dimensions and configurations.

The ball striking device 100 may include a shaft 104 connected to or otherwise engaged with the ball striking head 102, as shown in FIG. 1. The shaft 104 is adapted to be gripped by a user to swing the ball striking device 100 to strike the ball. The shaft 104 can be formed as a separate piece connected to the head 102, such as by connecting to the hosel 109, as shown in FIG. 1. In other illustrative embodiments, at least a portion of the shaft 104 may be an integral piece with the head 102, and/or the head 102 need not contain a hosel 109 or may contain an internal hosel structure. Still further embodiments are contemplated without departing from the scope of the invention. The shaft 104 may be constructed from one or more of a variety of materials, including metals, ceramics, polymers, composites, or wood. In some illustrative embodiments, the shaft 104, or at least portions thereof, may be constructed of a metal, such as stainless steel or titanium, or a composite, such as a carbon/graphite fiber-polymer composite. However, it is contemplated that the shaft 104 may be constructed of different materials without departing from the scope of the invention, including conventional materials that are known and used in the art. A grip element 105 may be positioned on the shaft 104 to provide a golfer with a slip resistant surface with which to grasp golf club shaft 104, as shown in FIG. 1. The grip element 105 may be attached to the shaft 104 in any desired manner, including in conventional manners known and used in the art (e.g., via adhesives or cements, threads or other mechanical connectors, swedging/swaging, etc.).

Generally, the ball striking devices described herein, such as the golf club 100 illustrated in FIGS. 1-8, include complementary connecting structure on the head 102 and the shaft 104 to permit the head 102 to be removably connected to the shaft 104. In the embodiment illustrated in FIGS. 1-8, the head 102 includes connecting structure in the form of a connection member 130 that is connected to the distal end 129 of the hosel 109, which is configured for connection to the shaft 104. The connection member 130 as illustrated in FIGS. 1-8 is a post member 131 with a non-circular cross-section that extends away from the distal end 129 of the hosel 109. As shown in FIG. 3, the post member 131 in this embodiment has a square or other rectangular cross-section, but may have another non-circular cross-section in another embodiment, such as an oval cross-section, a triangular, pentagonal, hexagonal, octagonal, or other polygonal cross-section, a more complex and/or asymmetrically-shaped cross-section, etc. It is understood that the “cross-section” referred to is taken perpendicularly to the direction in which the post member 131 extends from the hosel 109.

The shaft 104 has connecting structure that is complementary with the connecting structure of the head 102 to connect the head 102 to the shaft 104. In one embodiment, the shaft 104 may have a connection member 140 that is configured to engage the connection member 130 of the head 102 to create this connection. For example, in the embodiment illustrated in FIGS. 1-8, the shaft 104 has a connection member 140 in the form of a bore 141 shaped similarly to the post member 131 (e.g. having a non-circular shape) that is located at the end 142 of the shaft 104 opposite the grip and is configured to receive the post member 131 therein to connect the head 102 to the shaft 104. In the embodiment shown in FIG. 1-8, the bore 141 may have a square or other rectangular cross-section, and the outer surface at the end 142 of the shaft 104 around the bore 141 is a different shape from the bore 141 (e.g. circular in this embodiment). In other embodiments, the outer surface at the end 142 of the shaft 104 may have a shape that is similar to the shape of the bore 141. For example, in another embodiment, the outer surface at the end 142 of the shaft 104 may have a square cross-section to match the square cross-section of the bore 141, or may have another cross-sectional shape to match the shape of the bore 141, if the bore is not square in shape. Other configurations may be used in further embodiments. The head 102 and/or the shaft 104 may have different connection members 130, 140 in other embodiments, such as the embodiments illustrated in FIG. 9.

It is understood that the non-circular shape of the post member 131 and the bore 141 cooperate to rotationally lock the post member 131 with respect to the bore 141 to resist rotation of the head 102. In one embodiment, at least a portion of the post member 131 may have a non-circular cross-section, and the post member 131 may have different length portions having different cross-sectional shapes. As one example, the post member 131 may have both a circular portion and a non-circular portion, with the non-circular portion providing rotational locking ability. Such a non-circular portion may be formed by tabs and/or recesses on the post member 131 that can engage complementary tabs and/or recesses in or around the bore 141. The bore 141 may likewise have circular and non-circular portions in one embodiment. Further configurations are possible in other embodiments, and other types of rotational locking structure between the connection members 130, 140 may be used to resist rotation of the head 102.

The connecting structure between the head 102 and the shaft 104 may further include an adhesive material that bonds the connection member 130 of the head 102 to the connection member 140 of the shaft 104. In the embodiment shown in FIGS. 6-8, an adhesive material 150 is located within the bore 141 and bonds the outer surface of the post member 131 to the inner surface of the bore 141, as shown in FIG. 7. The adhesive material 150 may be a commercial hot melt adhesive or other temperature sensitive adhesive material that can be heated to permit connection and/or removal of the bonded components. Such adhesives may incorporate one or more of: ethylene vinyl acetate (EVA), polyolefins such as polyethylene, polyurethanes, silicones, and other polymeric materials. This permits the head 102 to be removed, reconnected, and/or interchanged with respect to the shaft 104 by heating the adhesive material 150 to permit bonding or debonding between the connecting structures of the head 102 and the shaft 104, as described in further detail below. In other embodiments, different types of adhesive materials may be used, and the adhesive material 150 may bond different components of the head 102 and the shaft 104 together. It is understood that the usage and positioning of the adhesive material 150 may depend on the geometry of the connecting structures. In other embodiments, the connecting structure may additionally or alternately contain other types of removable or releasable locking structures, such as threaded connections, tab-and-slot connections, rotatable locking structures, fasteners (e.g. screws), etc.

The body 108, the face 112, and/or the hosel 109 of the golf club head 102 may be constructed from a wide variety of different materials, including materials conventionally known and used in the art, such as steel, titanium, aluminum, tungsten, graphite, polymers, or composites, or combinations thereof. Also, if desired, the club head 102 may be made from any number of pieces (e.g., having a separate face mask, etc.) and/or by any construction technique, including, for example, casting, forging, welding, bonding, and/or other methods known and used in the art. In the embodiment shown in FIGS. 1-8, the entire ball striking head 102, including the face 112, the body 108, and the hosel 109, is formed as a single, integral piece of polymer material, and may be manufactured by techniques such as injection molding to form a single integral member as described below. In another embodiment, the face 112, the body 108, and the hosel 109 may be formed of two or more separate pieces that are connected together by an integral joining technique or another joining technique. Examples of polymer materials that can be used to form the head 102 or components thereof include polyamides (e.g., nylon or aramids), polyethylene, polyvinyl chloride, polypropylene, polycarbonate, epoxy, and others. The polymer material(s) forming the head 102 may also include one or more reinforcing materials to increase strength, rigidity, and other mechanical properties. Examples of reinforcing materials that can be used include carbon/graphite fibers, glass fibers, polymer-based fibers (e.g. UHMWPE, Kevlar, etc.), and others. The polymer material can be formed using a variety of techniques, such as injection molding or other molding techniques, 3-D printing or other rapid prototyping techniques, prepreg processing, infiltration, or other composite processing techniques, or other polymer processing techniques available to those skilled in the art.

As described above, the head 102 may be removably connected to the shaft 104 in various embodiments, to permit the head 102 to be removed and reconnected, as well as replaced or interchanged with another head 102 having a similar connecting structure. The replacement head may be shaped and/or configured similarly to the previously-removed head 102 or may have one or more different properties or performance characteristics, such as a different size, configuration, shape, weighting, loft angle, etc. The head 102 may be replaced for a variety of different reasons. In one embodiment, the head 102 may be used for hitting a ball that sits on a playing surface that is hard, rough, abrasive, or otherwise or otherwise capable of damaging the head 102, such as a cart path, road, parking lot, etc. The removable connecting structure allows the head 102 to be replaced easily and at low cost when the head 102 becomes damaged through use. The user may thereby avoid the risk of damaging clubs that may be more difficult and costly to repair or replace. In another embodiment, the head 102 may be replaced with another head that has a different performance characteristic, e.g. a different loft angle or a different weighting configuration. In further embodiments, the head 102 may be removed and replaced for a different reason.

In one embodiment the head 102 and the shaft 104 of FIGS. 1-8 can be removably connected together through the use of the adhesive material 150 as described above. As shown in FIGS. 7-8, the adhesive material 150 is placed in communication with a surface of the connection member 130 of the head 102 (e.g. the outer surface of the post member 131) and with a surface of the connection member 140 of the shaft 104 (e.g. the inner surface of the bore 141) at elevated temperature sufficient to permit the adhesive material 150 to be bonded or debonded with adjacent surfaces. This temperature may be based on the glass transition temperature of the adhesive material 150 in one embodiment, and the glass transition temperature of the adhesive material 150 may be lower than the glass transition temperature of polymer materials forming any associated structural components, such as the polymer material forming the connection member 130 of the head 102 (e.g., the post member 131). In this embodiment, the adhesive material 150 has a glass transition temperature that is lower than the glass transition temperature of the polymer material of the head 102. In this embodiment, heating the adhesive material 150 to a temperature between the glass transition temperature of the adhesive material 150 and the glass transition temperature of the polymer material of the head 102 when connecting the head 102 to the shaft 104 permits the adhesive material 150 to be bonded or debonded without affecting the structural integrity of the post member 131 or other structures made from polymer materials. The adhesive material is then cooled after connecting the shaft 104 to the head 102, so that the adhesive material bonds the connection member 140 of the shaft 104 to the connection member 130 of the head 102, as shown in FIG. 7.

When the head 102 is to be removed from the shaft 104, the adhesive material 150 is heated a second time to a temperature above the glass transition temperature of the adhesive material to permit the post member 131 to be debonded and removed from the bore 141, as shown in FIG. 8. After removal, the head 102 may be interchanged with a second head 102′ is shown in FIG. 2. The second head 102′ in this embodiment has a similar configuration to the original head 102, but may have a different configuration in other embodiments. The second head 102′ may also be at least partially formed of a polymer material, and may be formed of a single integral piece of the polymer material in one embodiment. The second head 102′ may be connected to the shaft 104 in a similar manner as the original head 102. If the polymer material of the second head 102′ is different from that of the original head 102, then generally the second polymer material will also have a glass transition temperature that is higher than the glass transition temperature of the adhesive material 150. As described above, in other embodiments, another type of releasable connecting structure may additionally or alternately be used to connect the head 102 to the shaft 104. In such a configuration, the method of replacing or interchanging the heads 102, 102′ may include releasing and connecting such additional connecting structure.

In one embodiment, the head 102 may include weights 160 that are connected to the head 102, which influence the weighting of the head 102, such as the center of gravity (CG), moment of inertia (MOI), total weight, etc. FIG. 5 illustrates an embodiment of the head 102 as described above and shown in FIGS. 1-8 with integral weights 160 that are formed as part of the head 102. As shown in FIG. 5, the weights 160 are positioned low and rearward on the club head body 108 and toward the heel 120 and the toe 122, in order to shift the CG low and rearward on the head 102 and to increase the perimeter weighting and MOI of the head. Other configurations may be used to achieve different desired weighting configurations. These weights 160 can be formed by using a doping material with a greater density than the material of the head 102, so that the area or areas where the doping material is located have a higher density or weight than the other portions of the head 102. This allows the weighting and the weight distribution of the head to be controlled, adjusted, and/or customized. The weights 160 in this embodiment may be integrally formed with the head during a molding process. For example, a two-shot molding process may be used, with one shot containing a doped polymer and the other shot containing a non-doped polymer. The polymer materials used for both shots may be the same. As another example, the weights 160 may be inserted into the mold cavity before the polymer material of the head 102 is injected into the cavity.

One example of a dense doping material that can be used to form the weights 160 is tungsten powder, although other dense metals or other materials may be used, including stainless steel, brass, copper, lead, etc., as well as non-metals such as various oxides, sulfates, etc. Additionally, in one embodiment, doped or weighted portions having substantially identical sizes, but with densities that vary ten-fold, such as from 1.2-12.0 g/cc, can be created by using different doping materials and/or different volume fractions of doping materials in the doped portions. In a further embodiment, the weights 160 may be external weights that are removably connected to the club head body 108, such as by a threaded, snap-fit, or rotational locking connection, and the external weights 160 may be disconnected from a head 102 when removed and reconnected to the replacement head 102′. Still further weighting configurations may be used, including weighting configurations known in the art.

FIG. 9 illustrates another embodiment of a ball striking device 200 with a head 102 and shaft 104 that have connecting structures 130, 140 that are configured differently from the head 102 and shaft 104 of the ball striking device 100 of FIGS. 1-8. In this embodiment, the orientations of the connecting structures 130, 140 are transposed with respect to the embodiment of FIGS. 1-8. As seen in FIG. 9, the connecting structure 140 of the shaft 104 includes a post member 143, and the connecting structure 130 of the head 102 includes a bore 132 that receives the post member 143. The post member 143 and the bore 132 may have non-circular cross-sectional shapes as similarly described above, which can assist in achieving rotational locking. Additionally, the post member 143 and the bore 132 may be connected using an adhesive material (not shown) as similarly described above with respect to FIGS. 6-8. Any other features of the head 102 and shaft 104 described above, including different types of connecting structures 130, 140, may also be used in connection with this embodiment.

Several different embodiments have been described above, including the various embodiments of golf clubs 100 and heads 102 and portions thereof described herein. It is understood that any of the features of these various embodiments may be combined and/or interchanged. For example, as described above, various different combinations of connecting structures may be used, including the configurations described herein, variations or combinations of such configurations, or other configurations. Generally, the features described herein with respect to separate embodiments can be used in combination, although some such combinations may require modification from the depicted structures. In further embodiments, at least some of the features and techniques described herein, including the use of various connecting structures and weights may be utilized or incorporated within other types of golf club heads or other ball-striking devices. For example, these features can be used in a wood-type golf club, a hybrid-type golf club, a putter, or another type of golf club, golf club head, or other ball striking device.

A golf club 100 as shown in FIG. 1 may be manufactured by attaching a shaft or handle 104 to a head that is provided, such as the head 102 as described above. “Providing” the head, as used herein, refers broadly to making an article available or accessible for future actions to be performed on the article, and does not connote that the party providing the article has manufactured, produced, or supplied the article or that the party providing the article has ownership or control of the article. In other embodiments, different types of ball striking devices can be manufactured according to the principles described herein. In one embodiment, a set of golf clubs can be manufactured, where at least one of the clubs is configured according to one or more embodiments described herein. It is understood that the clubs in such a set may have progressively increasing loft angles, may include iron-type clubs, wood-type clubs, hybrid-type clubs, putters, or a combination of two or more of such club types. The clubs in such a set may have progressive weighting, such that the center of gravity is located differently on different clubs. For example, the center of gravity may be lower on longer irons, in order to better facilitate getting the ball airborne, and may be higher on shorter irons, in order to achieve greater control. The weights 160 described above may assist in achieving such progressive weighting.

Additionally, as described above, the head 102, et seq., golf club 100, or other ball striking device may be fitted or customized for a person by custom fitting, which may include selecting a specific head 102 and/or a specific shaft 104 with desired characteristics and connecting the head 102 to the shaft 104 to create the golf club 100. Various other different configurations are possible, and various other club heads may be designed for various performance characteristics.

The ball striking devices and heads therefor as described herein provide many benefits and advantages over existing products. For example, the head of the ball striking device can be removed and interchanged with other heads, which can permit the head to be replaced easily. A ball striking device having a replaceable head can thereby be provided for use in hitting a ball in situations where risk of damage to the head is significant, such as hitting a golf ball sitting on a damaging playing surface. The head can be replaced when it becomes damaged. Additionally, the use of a head made of a polymer material permits the head to be replaced at low cost. As another example, the interchangeability features permit a head to be replaced with another head having a different structure, configuration, performance characteristic, etc., as desired. As a further example, the weighting configurations described herein can provide different performance characteristics for the head. Still further benefits and advantages may be recognizable by those skilled in the art.

While the invention has been described with respect to specific examples including presently preferred modes of carrying out the invention, those skilled in the art will appreciate that there are numerous variations and permutations of the above described systems and methods. Thus, the spirit and scope of the invention should be construed broadly as set forth in the appended claims.

What is claimed is:

1. An iron-type golf club head comprising:
a face having a striking surface configured for striking a ball;
an iron-type golf club head body connected to the face and extending rearward from the face;
a hosel having a proximal end connected to the body and a distal end extending away from the body; and
a post member connected to the distal end of the hosel and extending away from the hosel, the post member having a non-circular cross-section and being configured for insertion into a shaft to connect the golf club head to the shaft,
wherein the face, the body, the hosel, and the post member are integrally formed of a single piece of a polymer material.

2. The golf club head of claim 1, wherein the post member has a rectangular cross section.

3. A ball striking device comprising the golf club head of claim 1 and a shaft connected to the golf club head, wherein the shaft comprises a bore receiving the post member therein.

4. The ball striking device of claim 3, further comprising an adhesive material bonding the shaft to the post member, wherein the adhesive material has a glass transition temperature that is lower than a glass transition temperature of the polymer material of the post member, and wherein the shaft is configured to be connected to and disconnected from the post member by heating the adhesive material to a temperature between the glass transition temperature of the adhesive material and the glass transition temperature of the polymer material to permit the adhesive material to be bonded or debonded without damage to the shaft or the post member.

5. A ball striking device comprising:
a ball striking head comprising:
a face having a striking surface configured for striking a ball;
a body connected to the face and extending rearward from the face;
a hosel having a proximal end connected to the body and a distal end extending away from the body; and
a connection member connected to the distal end of the hosel, wherein the face, the body, the hosel, and the connection member are formed of a polymer material;
a shaft removably connected to the connection member of the ball striking head; and
an adhesive material bonding the shaft to the connection member of the ball striking head, wherein the adhesive material has a glass transition temperature that is lower than a glass transition temperature of the polymer material of the connection member, and wherein the shaft is configured to be connected to and disconnected from the connection member by heating the adhesive material to a temperature between the glass transition temperature of the adhesive material and the glass transition temperature of the polymer material to permit the adhesive material to be bonded or debonded without damage to the shaft or the connection member.

6. The ball striking device of claim 5, wherein the connection member comprises a post member extending from the distal end of the hosel and the shaft comprises a bore receiving the post member therein, wherein the post member has a non-circular cross-section and the bore has a complementary non-circular cross-section, such that the post member and the bore are rotationally locked.

7. The ball striking device of claim 6, wherein the face, the body, the hosel, and the post member of the ball striking head are integrally formed of a single piece of the polymer material.

8. The ball striking device of claim 6, wherein the post member and the bore have rectangular cross-sections.

9. The ball striking device of claim 5, wherein the shaft comprises a post member extending from an end of the shaft and the connection member comprises a bore within the distal end of the hosel and receiving the post member therein, wherein the post member has a non-circular cross-section and the bore has a complementary non-circular cross-section, such that the post member and the bore are rotationally locked.

10. The ball striking device of claim 9, wherein the face, the body, and the hosel of the ball striking head are integrally formed of a single piece of the polymer material.

11. The ball striking device of claim 9, wherein the post member and the bore have rectangular cross-sections.

12. The ball striking device of claim 5, wherein the face, the body, and the hosel of the ball striking head are integrally formed of a single piece of the polymer material.

13. A ball striking device comprising:
a ball striking head comprising:
a face having a striking surface configured for striking a ball;
a body connected to the face and extending rearward from the face; and
a hosel having a proximal end connected to the body and a distal end extending away from the body, wherein the face, the body, and the hosel are integrally formed of a single piece of a polymer material; and
a shaft removably connected to the hosel of the ball striking head.

14. The ball striking device of claim 13, wherein the ball striking head further comprises a post member extending from the distal end of the hosel and the shaft comprises a bore receiving the post member therein, wherein the post member has a non-circular cross-section and the bore has a complementary non-circular cross-section, such that the post member and the bore are rotationally locked.

15. The ball striking device of claim 14, wherein the post member is also integrally formed as part of the single piece of the polymer material.

16. The ball striking device of claim 15, further comprising an adhesive material bonding the shaft to the post member, wherein the adhesive material has a glass transition temperature that is lower than a glass transition temperature of the polymer material of the post member, and wherein the shaft is configured to be connected to and disconnected from the post member by heating the adhesive material to a temperature between the glass transition temperature of the adhesive material and the glass transition temperature of the polymer material to permit the adhesive material to be bonded or debonded without damage to the shaft or the post member.

17. The ball striking device of claim 14, wherein the post member and the bore have rectangular cross-sections.

18. The ball striking device of claim 13, wherein the shaft comprises a post member extending from an end of the shaft and the ball striking head further comprises a bore within the distal end of the hosel and receiving the post member therein, wherein the post member has a non-circular cross-section and the bore has a complementary non-circular cross-section, such that the post member and the bore are rotationally locked.

19. The ball striking device of claim 18, wherein the post member and the bore have rectangular cross-sections.

20. The ball striking device of claim 13, further comprising an adhesive material bonding the shaft to the hosel, wherein the adhesive material has a glass transition temperature that is lower than a glass transition temperature of the polymer material of the hosel, and wherein the shaft is configured to be connected to and disconnected from the hosel by heating the adhesive material to a temperature between the glass transition temperature of the adhesive material and the glass transition temperature of the polymer material to permit the adhesive material to be bonded or debonded without damage to the shaft or the hosel.

21. A method comprising:
providing a ball striking head comprising:
a face having a striking surface configured for striking a ball;
a body connected to the face and extending rearward from the face;
a hosel having a proximal end connected to the body and a distal end extending away from the body; and
a connection member connected to the distal end of the hosel, wherein at least a portion of the head is formed of a polymer material;
placing an adhesive material in communication with a surface of the connection member of the ball striking head, wherein the adhesive material has a glass transition temperature that is lower than a glass transition temperature of the polymer material of the head;
heating the adhesive material to a temperature between the glass transition temperature of the adhesive material and the glass transition temperature of the polymer material;
connecting a shaft to the connection member of the ball striking head by placing a portion of the shaft in communication with the adhesive material; and
cooling the adhesive material after connecting the shaft to the connection member, such that the adhesive material bonds the shaft to the connection member of the ball striking head.

22. The method of claim 21, wherein the face, the body, and the hosel of the ball striking head are integrally formed of a single piece of the polymer material.

23. The method of claim 21, wherein the connection member of the ball striking head comprises a post member extending from the distal end of the hosel and the shaft comprises a bore, wherein the shaft is connected to the connection member by inserting the post member in the bore, wherein the adhesive material is located within the bore to bond the post member to the shaft, and wherein the post member has a non-circular cross-section and the bore has a complementary non-circular cross-section, such that the post member and the bore are rotationally locked after connection.

24. The method of claim 23, wherein the face, the body, the hosel, and the post member of the ball striking head are integrally formed of a single piece of the polymer material.

25. The method of claim 21, further comprising:
heating the adhesive material a second time to a temperature between the glass transition temperature of the adhesive material and the glass transition temperature of the polymer material;
disconnecting the shaft from the connection member of the ball striking head after heating the adhesive material the second time;
providing a second ball striking head comprising:
a face having a striking surface configured for striking a ball;
a body connected to the face and extending rearward from the face;
a hosel having a proximal end connected to the body and a distal end extending away from the body; and
a connection member connected to the distal end of the hosel, wherein at least a portion of the head is formed of a second polymer material;
connecting the shaft to the connection member of the second ball striking head by placing a portion of the shaft in communication with the adhesive material; and
cooling the adhesive material after connecting the shaft to the connection member of the second ball striking head, such that the adhesive material bonds the shaft to the connection member of the second ball striking head.

26. The method of claim 25, wherein the face, the body, and the hosel of the ball striking head are integrally formed of a single piece of the polymer material, and the face, the body, and the hosel of the second ball striking head are integrally formed of a single piece of the second polymer material.

27. The method of claim 25, wherein the connection member of the ball striking head comprises a post member extending from the distal end of the hosel and the shaft comprises a bore, wherein the shaft is connected to the connection member by inserting the post member in the bore, wherein the adhesive material is located within the bore to bond the post member to the shaft, and wherein the post member has a non-circular cross-section and the bore has a complementary non-circular cross-section, such that the post member and the bore are rotationally locked after connection, and wherein the connection member of the second ball striking head comprises a post member extending from the distal end of the hosel and the shaft comprises a bore, wherein the shaft is connected to the connection member by inserting the post member in the bore, wherein the adhesive material is located within the bore to bond the post member to the shaft, and wherein the post member has the non-circular cross-section of the post member of the ball striking head, such that the post member of the second ball striking head and the bore are rotationally locked after connection.

28. The method of claim 27, wherein the face, the body, the hosel, and the post member of the ball striking head are integrally formed of a single piece of the polymer material, and the face, the body, the hosel, and the post member of the second ball striking head are integrally formed of a single piece of the second polymer material.

29. The method of claim 25, wherein the polymer material is substantially the same as the second polymer material.
